(19) United States
(12) Patent Application Publication
(10) Pub. No.: US 2008/0298042 A1
(43) Pub. Date: Dec. 4, 2008

(54) Apparatus and method for providing an insulated support rack

(76) Inventor: Richard J. Fox, IV, Branchburg, NJ (US)

Correspondence Address: Noam J. Kritzer, Esq. / Bakos & Kritzer, 27 Laurel Avenue, Summit, NJ, 07901, US

(21) Appl. No.: 11/809,210

(22) Filed: May 30, 2007

(51) Int. Cl. H02B 1/01

(52) U.S. Cl. 361/825

(57) ABSTRACT

A system and method are disclosed for providing an improved rack arm system wherein insulating material is utilized to guard against stray voltage. The system and method entail providing insulated rack arm systems for installation in new locations as well as a snap-on insulating piece for utilization with existing rack arm systems.

### FIELD OF THE INVENTION

The present invention generally relates to the field of support systems for cables, including power and communication cables. More specifically, the present invention relates to an apparatus and method for insulating existing support racks supporting such cables, primarily in underground conduits providing access to generation points and termination points in various structures such as buildings, residential developments, and the like. Also the present invention relates to the creation and installation of pre-insulated support racks for supporting cables.

### BACKGROUND OF THE INVENTION

Cables, such as electric power and other like cable systems are typically located in underground tunnels. For purposes of disclosure of the present invention herein, cables are generally referred to as any insulated conductor or combination of insulated conductors, and/or a fiber or group of fibers. Underground tunnels provide funnels to various access and termination points as well as protection for the telephone/electrical cables and conduits disposed therein, primarily from human interference. It is preferred in the art that the cables are installed in underground locations as the cables are often considered unsightly and can be dangerous if humans interfere with the cables. Further, one of ordinary skill in the art can easily recognize that such cables incur damage when installed in above-ground locations such as attached to common telephone/electrical poles or other like through structures due to the influences of environmental changes, primarily climatic fluctuation.

While it is desirable to install cables underground to protect the cables from human interference and to protect humans from interaction with the cables as well as other common above-ground hazards, the underground location does not prevent all problems. For example, environmental factors such as temperature, moisture, humidity, precipitation, and flooding are always potential dangers. In addition, underground vermin typically destroy cable components, including insulation required to protect the cables and the electrical conduits. Vermin are especially destructive to cable runs and assemblies if the runs and assemblies are positioned at points in close proximity to the ground or easily accessible from the ground. As a result, underground utility lines in typical installations generally require extra insulation due to the harsh underground environment.

Therefore, it is well known in the art that such communication and power cables must be kept off the ground, organized and secured, and protected from the surrounding underground environment. Public Utility Commissions have recognized this need to provide organized and secured environments for cable runs and have enacted numerous regulations providing guidance for the installation of underground cables. For example, in July 2006, the Public Utilities Commission of the State of California enacted General Order No. 128. This Order prescribed the particular placement of utility cables in underground installations, including clearance and depth requirements of supply cables in various environments. The primary purpose of the Order is to provide safe installations of cables. In particular the installations must be safe from human interaction and must also be safe for routine maintenance while providing the desired purpose of offering a means to transfer electrical power from a first point of generation to a second point of intermediate or final termination.

To solve these problems and adhere to Public Utilities' guidelines and orders, cable and power support providers have installed racks to support such cables at desired depths. These racks typically ensure that cables do not touch the ground, thereby protecting them from rising water and vermin. It is well known in the art that such racks must be able to withstand a varying range of temperatures and humidity while supporting heavy power and communication cabling structures at long runs. In addition, the racks must be constructed of sufficiently strong material to withstand considerable vibration as the cable runs are frequently strung through passages beneath vehicular roadways, train thruways, or other points subject to heavy vibration.

Further, the rack system must be erected for supporting large numbers of electrical cables as commonly employed for the transmission of electricity. Thus, it is even more evident, that the rack system must be constructed of sturdy construction and be capable of supporting the substantial weight of electrical cable or a series of electrical cables. In addition, the rack must be capable of quick and relatively inexpensive installation, replacement, and removal.

Further, in existing installations and in new installations, the support rack systems utilized must be capable of supporting electrical cables and conduits that can have extremely high voltages levels. These voltage levels of varying voltages are extremely dangerous to workers. While many safety precautions are adopted to protect workers in the field, it is obvious to those of skill in the art that insulation is required as a primary safety precaution to ensure that people are not injured by the strong currents carried by the conducting material of the cables.

To protect against electrocution in these cable rack installations, existing solutions attempt to safeguard the cable environment in various ways. However, existing systems provide insulation by using expensive, impractical systems and methods. These systems primarily have three major disadvantages. First, the systems are expensive to manufacture, install, and replace. Second, the systems are ineffective in providing adequate strength to support heavy cables and are ineffective in providing adequate protection to workers as they often fail to properly adhere to existing cable rack systems, become unraveled, or deteriorate over time. Finally, these systems fail to provide an adequate apparatus and method for retrofitting existing systems and are only useful in new cable run assemblies.

One such existing solution involves wrapping tape around an existing support rack. While this solution insulates against lower voltages, several disadvantages remain. For example, at higher voltages, electricity can still be conducted through the wrapped tape. In addition, wrapping tape around a support rack interferes with the support and load-balancing properties with which support racks are designed. The tape is also subject to the wear and tear associated with the underground conditions and often tears, unravels, or is otherwise rendered ineffective. Further, installing wrapping tape in the field requires extensive manual labor which is often expensive and subject to irregular application in the confined space of an underground cable installation such as a cable vault. Finally, the elimination or reduction of stray voltage concerns are not addressed. Stray voltage occurs when electrical wires accidentally come in contact with exposed conductive parts like vault gratings which may cause injuries and fatalities to members of the public.

Another existing solution is to connect a grounding mechanism from the existing support rack to a location in contact with the ground. In this way, in the event of a surge from the cable, or a voltage leak from the cable to the rack support, the excess voltage would be carried to the ground. In this scenario, by carrying the voltage to the ground, the support structure is protected from the stray current reducing the likelihood of damage to the support. There are, however, disadvantages associated with this solution. First, the potential for failure of such a system to operate due to malfunction or corrosion-related damage is a prominent problem in the field. In addition, the material and labor costs associated with procuring and implementing the installation of such a grounding mechanism for each existing support rack is generally prohibitive. Further, the application of this type of grounding mechanism yields an added step during the installation in the field which may be difficult and impractical for certain installations depending on particular environmental or structural characteristics. In addition, it is likely that overtime, stray currents may follow alternate paths with less resistance should such paths become available. Finally, one of ordinary skill in the art will readily recognize that since the rack/stanchion are already grounded (i.e., the rack and stanchion combination are bolted into the wall of the vault), this application fails to prevent a fault between the cable and the ground.

Yet another existing solution is to provide a non-metallic support rack. For example, U.S. Pat. No. 5,092,546 to Wolfbauer discloses a non-conductive support system. By providing a support rack that is non-conductive, Wolfbauer purports to solve the surging voltage problem by installing new, non-conductive support racks in place of existing support racks. One disadvantage of the system disclosed by Wolfbauer is the replacement of a steel product with a plastic product, thereby sacrificing quality and durability. Due to the extended lengths of cable runs and the heavy installation and material components of cables or cable conduits, plastic-based rack systems are subject to strength deficiencies and may also be subject to sudden calamitous failure. Further, due to the intense vibration associated with underground installations located below vehicular roadways, plastics and related materials are not of sufficient strange to provide long-term support for cables and cable conduits. Also, as with other solutions, due to the additional materials and labor costs associated with installation installing non-conductive support racks is an untenable solution. Further, in certain instances, field conditions may require a malleable construction rather than a plastic construction which if bent may quickly shear at a particular stress point resulting in product failure and increased labor and material costs. It is also apparent in the art that rack systems of this nature that are primarily plastic, fiberglass, or some combination thereof, are often expensive to manufacture and install and as a result are cost-prohibitive in the art.

One final solution implemented by those of skill in the art is to cover existing support racks with a porcelain cover. It is evident that a porcelain cover is non-conductive but several disadvantages of this application are evident. For example, one disadvantage of this potential solution is the fragile nature of porcelain, which can crack under the heavy loads carried by support racks. Further, porcelain construction is often expensive. In addition, similar to the previous solution, a porcelain covered product is susceptible to shearing in the field should field conditions require any manipulation of the device.

It is therefore clear that a need exists for an apparatus and method to facilitate the insulation of existing support racks without sacrificing the quality and durability of a steel product. Likewise, a need exists for an apparatus and method to provide new insulated support racks without sacrificing the quality and durability of a steel product. It is also preferred that the resulting product is constructed of a cost-efficient material and is cost-efficient for field installation from a labor perspective.

### SUMMARY OF THE INVENTION

The present invention provides an apparatus to facilitate the insulation of existing support racks by providing an insulated cover to shield existing steel support racks from stray or surging voltage. In this way, the present invention enables users to continue to utilize existing support rack systems without sacrificing the level of quality or durability that is customary in current field applications. The rack arm cover is a safeguard to preventing faults at points of cable insulation wear or failure resulting in failure as the rack arm and stanchion may be energized. In addition, the rack arm cover of the present invention safeguards against stray voltage occurrences that could be the result of electrical wires interacting with exposed conductive parts such as vault gratings.

The present invention also provides a method for installing such insulated covers in order to utilize and protect existing steel support racks from stray or surging voltage thereby providing a cost-effective and safe field application.

In addition, disclosed is a method and apparatus for installing new support rack arms containing such insulated covers in order to protect new steel support racks from stray or surging voltage.

Other objects, features, and characteristics of the present invention, as well as the methods of operation, installation, and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment and an alternate embodiment as set forth in the illustrations of the accompanying drawings. Although the illustrated embodiments are merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the present invention.

FIG. 1 depicts a prior art system showing an existing cable rack arm.

FIG. 2A depicts a top view of the insulating cover for an existing rack arm in accordance with the preferred embodiment of the present invention.

FIG. 2B depicts a side view of the insulating cover for an existing rack arm in accordance with the preferred embodiment of the present invention depicted in FIG. 2A.

FIG. 3A depicts a top view of the insulating cover for an existing rack arm installed in an existing cable installation in accordance with an alternative embodiment of the present invention.

FIG. 3B depicts a side view of the insulating cover for an existing rack arm in accordance with the alternative embodiment of the present invention depicted in FIG. 3A.

FIG. 3C depicts a cross section view of the snap-on means for attaching the insulating cover for an existing rack arm utilized in existing cable installations in accordance with the alternative embodiment of the present invention depicted in FIG. 3A.

### DETAILED DESCRIPTION OF THE PREFERRED EMBODIMENT

A detailed illustrative embodiment of the present invention is disclosed herein. However, techniques, systems and operating structures in accordance with the present invention may be embodied in a wide variety of forms and modes, some of which may be quite different from those in the disclosed preferred embodiment and alternate embodiments.

Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

Moreover, well known methods, procedures, and substances for both carrying out the objectives of the present invention and illustrating the preferred and alternate embodiments are incorporated herein but have not been described in detail as not to unnecessarily obscure novel aspects of the present invention.

Generally, rack arm systems are mounted on and between a floor and ceiling, typically in an underground installation. Alternate forms of present day rack arm systems are mounted on the floor adjacent to a wall. It should be noted that the floor and wall can be located anywhere and is not intended to limit the application of the invention.

Rack arm systems generally have upright supports having a back portion and opposite sides coextensively extending in spaced, parallel relation from the back portion. While the supports can be positioned transversely of U-shape, it is understood that they may be of other configuration and may potentially provide the opposite sides for a configuration. The support has a lower end and an upper end which afford laterally extended mounting flanges through which are secured bolts to mount the support in vertically standing relation on and between the floor and ceiling. The support can also be mounted by any other suitable means, such as by welding or other adhesion methods. Further, the support need not be extended from floor to ceiling—it can be suspended from a support, upwardly extended from a base, or otherwise sustained in position.

Rack arm systems further provide a plurality of support arms mounted horizontally thereon. Rack arm systems are generally designed to mount to a variety of types of arms for use in a variety of situations, but their transverse shape and manner of mounting are substantially the same. Each of the arms has cable supporting portions oppositely extended from the support and a central attachment portion received in the support.

Each of the arms is individually received in a passage of the support so that the portions of the arm extend on opposite sides of the support. With the notches in alignment with the opposite sides of the support, the arm is slid downwardly so that the opposite sides at the lower ends of the slot are received in the notches. So positioned in the passages, a gap is provided between the top wall of each arm and the upper end or shoulder of each passage. The gap preferably has a vertical dimension substantially equal to the extent to which the notches fit downwardly over the lips.

To construct such a rack arm system, the supports are secured on and between the floor and ceiling by bolts to retain the supports in upright relation. Although bolts made of steel are commonly utilized in the art, one of ordinary skill in the art will readily recognize that such attachment structures may take various forms, such as screws, ties, etc. manufactured of any other material of sufficient strength and density to support heavy gauged cables and conduits, such as alternate metals, plastics, etc. Depending upon the number and diameter of cables to be supported on the rack, the arms of the first form are received through selected passages so as to provide a sufficient number of arms with sufficient space for the cables to be supported thereon. The arms are easily positioned simply by sliding them endwardly through their respective passages until the notches are in juxtaposition to the lips and the arms thrust downwardly to fit the notches over their respective lips.

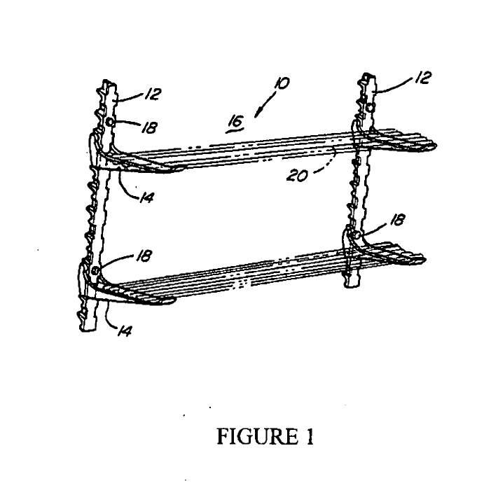

Referring first to FIG. 1, depicted is an illustration of prior art rack arm system 10 for use with known systems in the art. The depicted rack arm support system shows vertical support structures 12 and brackets 14.

As is understood by persons of ordinary skill in the art, vertical support structures 12 are typically fitted in place and secured against wall 16. FIG. 1 depicts a prior art rack arm system having two vertical support structures 12, though multiple or single vertical support structures depending on the desired application can be utilized as is well known in the art. Vertical support structures 12 are generally fitted to wall 16 by various fastening means, including fasteners 18.

Still referring to FIG. 1, shown is prior art rack arm system 10 utilized to hold or convey one or more tubular structures 20. Tubular structures 20 can include conduits or electrical wires, and can include structures having a small diameter.

As is known in the art, tubular structures 20 may be substituted by support systems such as shelves to support such things as corrosive or radioactive materials or any material requiring support that would be best supported by a non-metallic, non-conductive and corrosion-resistant support structure.

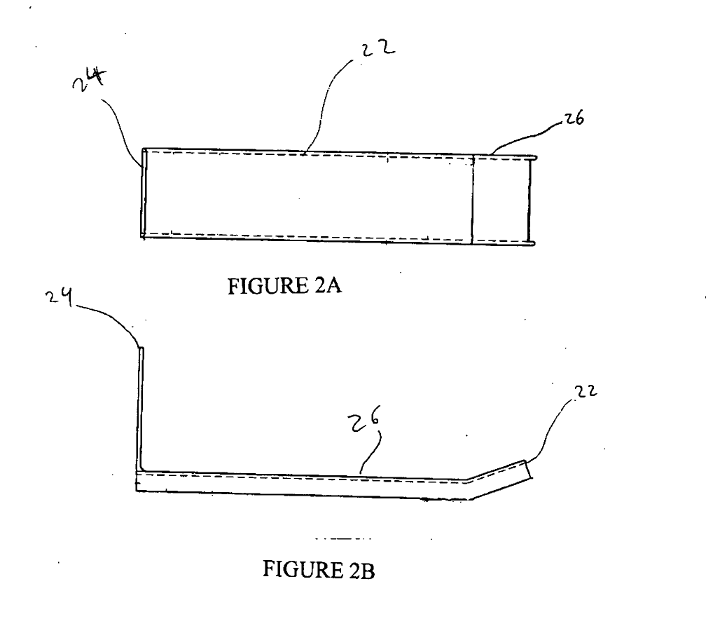

Referring next to FIG. 2A, depicted is a top view of the insulating cover for an existing rack arm in accordance with the preferred embodiment of the present invention. Depicted is horizontal member 22 utilized for supporting electrical-current carrying cables. In accordance with the preferred embodiment of the present invention, horizontal member 22 is connected to vertical member 24 by any known connection means. In an alternative embodiment, horizontal member 22 and vertical member 24 can comprise a single piece. Vertical member 24 attaches to a support member (not shown) in order to allow horizontal member 22 to provide adequate support for cables.

As is known in the art, horizontal member 22 is connected to a support member (not shown) in order to support electrical current-carrying cables. Such support member is generally fixed to a wall or other immobile structure in order to allow for support of the heaviest cable load.

Still referring to FIG. 2A, horizontal member 22 is generally comprised of a heavy-duty metal such as steel. Although the present embodiment is directed to a steel-type application, one of ordinary skill in the art will readily recognize that the principles disclosed herein may easily be adapted or modified to various other rack systems constructed of various materials such as plastics, polypropylene, polyethylene, polystyrene, acrylic, acrylonitrile butadiene styrene, styrene, acrylonitrile, other metal structures, etc. The preferred embodiment of the present invention includes coating material 26 to insulate the metal from the current carried by the electrical cable load. Coating material 26 is preferably a soft plastic material to enable support of high weight cable load without distorting present capacity loads of existing steel rack arms. In addition, the coating material of the preferred embodiment of the present invention is constructed of suitable material to withstand high temperatures, preferably temperatures of up to at least three hundred degrees Fahrenheit. The coating material used in the manufacture can be varied and modified to accommodate and even exceed any temperature restriction that may be commonly encountered in the field.

The range of acceptable dimensions of horizontal member 22 and vertical member 24 are well known in the art and it is contemplated by the present disclosure that the principles disclosed herein can be applied to all various dimensions including those common in the art as well as future applications deviating from current standard dimensions. The preferred embodiment of the present invention increases the dimensions of standard rack arm systems by adding a thin layer of insulation thereto. The change in dimension is therefore negligible in practice when compared with the overall length and width of existing rack arm systems.

Referring next to FIG. 2B, shown is a side view of the insulating cover for an existing rack arm in accordance with the preferred embodiment of the present invention depicted in FIG. 2A. Shown is horizontal member 22 having coating material 26. As shown, horizontal member 22 need not strictly be horizontal, as one end may be slanted to improve security of the cable load. Vertical member 24 is depicted as connected to horizontal member 22, however as discussed above both can comprise a single unit.

It should be noted that although FIG. 2B does not depict the attachment of insulating material 36 to vertical member 34, attachment of insulating material 36 to vertical member 34 has been contemplated.

The preferred embodiment depicted in FIG. 2A and FIG. 2B and described above is preferably manufactured as a single component. Thus, during installation of new rack arm systems where the transfer of stray voltage is concerned, the preferred embodiment described above can be utilized to insulate the rack arm system from stray voltage.

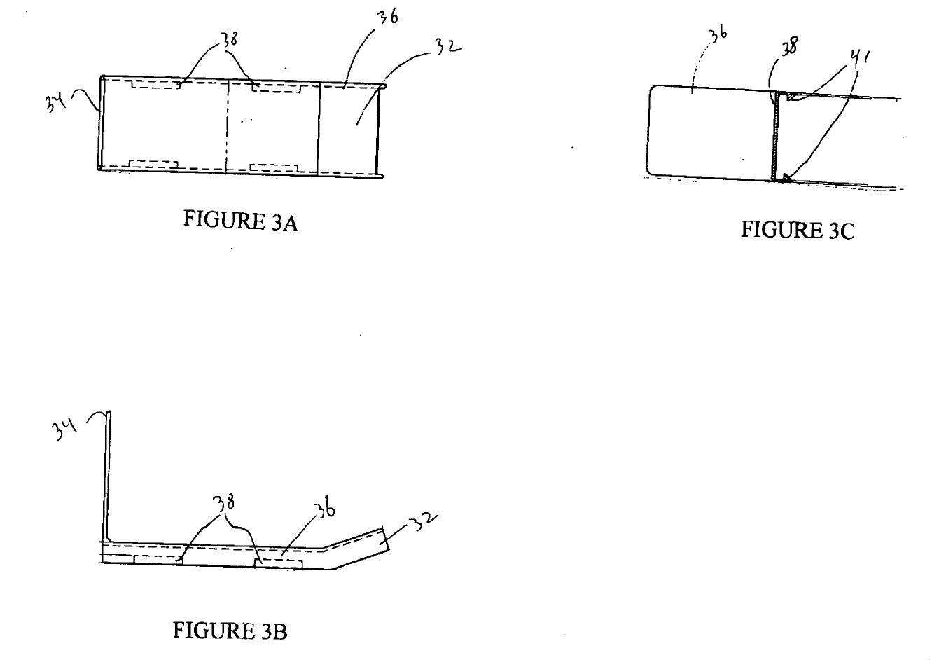

Referring next to FIG. 3A, shown is a top view of the insulating cover for an existing rack arm in accordance with an alternative embodiment of the present invention. With respect to this alternative embodiment, shown is a component that attaches to existing rack arm systems in order to provide insulation from stray voltage.

FIG. 3A depicts horizontal member 32 and vertical member 34. These members generally do not differ from horizontal member 22 and vertical member 24 as described with respect to FIGS. 2A and 2B. Horizontal member 32 and vertical member 34 are generally constructed of a heavy duty material (e.g., steel) to accommodate heavy cable loads. Further depicted in FIG. 3A is a separate attachment comprising insulating material 36. In this alternative embodiment of the present invention, insulating material 36 is attached to horizontal member 32 through any known or yet unknown attaching means. In the specific embodiment described in FIG. 3A, insulating material 36 is attached to horizontal member 32 via snap-on means 38.

Referring next to FIG. 3B, shown is a side view of the insulating cover for an existing rack arm in accordance with the alternative embodiment of the present invention depicted in FIG. 3A. This view depicts the relationship of insulating material 36 attached to horizontal member 32 using snap-on means 38.

It should be noted that although FIG. 3B does not depict the attachment of insulating material 36 to vertical member 34, attachment of insulating material 36 to vertical member 34 using snap-on means 38 has been contemplated.

Referring next to FIG. 3C, shown is a cross section view of snap-on means 38 for attaching insulating material 36 to horizontal member 32 in accordance with the alternative embodiment of the present invention depicted in FIG. 3A. Insulating material 36 is connected to snap-on means 38 by any attachment means heretofore known or later discovered. The width of snap-on means 38 is identical or negligibly different than the width of horizontal member 32. By applying pressure to the lateral end of insulating means 36, clips 41 surround horizontal member 32.

By virtue of the shape of clips 41, snap-on means 38 is not readily detachable from horizontal member 32 without human interference. That is, should the user decide to disengage insulating material 36 from horizontal member 32, the user can apply pressure to clips 41 transversally to disengage the two components.

It is understood by those of ordinary skill in the art that without human interaction, clips 41 serve to keep insulating material 36 attached to horizontal member 32. In addition, because application of the heavy cable load is to insulating material 36, the additional pressure keeps snap-on means 38 engaged with horizontal member 32.

What is claimed is:

1) An improved rack arm system for supporting electrical conduits and insulating against stray voltage comprising:
a support structure; and
at least one electrically conductive bracket interlocking with said support structure;
wherein said electrically conductive bracket is coated with an insulating material able to withstand temperatures up to 300 degrees Fahrenheit.

2) The improved rack arm system according to claim 1, wherein said insulating material is polypropylene.

3) The improved rack arm system according to claim 1, wherein said support structure is coated with said insulating material.

4) The improved rack arm system according to claim 3, wherein said insulating material is polypropylene.

5) An improved rack arm system for supporting electrical conduits and insulating against stray voltage comprising:
a support structure;
at least one electrically conductive bracket interlocking with said support structure; and
insulating material able to withstand temperatures up to 300 degrees Fahrenheit;
wherein said insulating material is attached to said electrically conductive bracket.

6) The improved rack arm system according to claim 5, wherein said insulating material is attached to said electrically conductive bracket using a snap-on means.

7) The improved rack arm system according to claim 5, wherein said insulating material is attached to said electrically conductive bracket using an adhesive means.

8) The improved rack arm system according to claim 5, wherein said insulating material is attached to said electrically conductive bracket using a screw-type means.

9) The improved rack arm system according to claim 5, wherein said insulating material is attached to said electrically conductive bracket using a slip-on means.

10) The improved rack arm system according to claim 6, wherein said insulating material is polypropylene.

11) The improved rack arm system according to claim 5, wherein said support structure is coated with said insulating material.

12) The improved rack arm system according to claim 5, wherein said support structure is integral with said insulating material.

13) The improved rack arm system according to claim 11, wherein said insulating material is a thermoplastic polymer.

14) A method for installing a rack arm protective cover to a rack arm system in an electrical cable installation wherein said rack arm protective cover is comprised of an insulating material and the method includes the steps of:
identifying an unprotected existing rack arm structure;
temporarily securing the cables supported by the rack arm system at a position to allow for the application of said rack arm protective cover;
adhering said protective cover including an insulating material to the rack arm system via an interlocking mechanism;
replacing said cables supported by the rack arm system; and
attaching said cables to said protective cover.

15) The method of claim 14 wherein said insulating material is composed of a material selected from the group of materials consisting of polypropylene, polyethylene, polystyrene, acrylic, acrylonitrile butadiene styrene, styrene, or acrylonitrile.

16) A method for installing a rack arm protective cover to a rack arm system in an electrical cable installation wherein said rack arm protective cover is comprised of an insulating material and the method includes the steps of:
securing cables and cable conduits supported by said rack arm system at a position to allow for the application of said rack arm protective cover;
adhering said protective cover including an insulating material to the rack arm system via an interlocking mechanism; and
replacing said cables and cable conduits supported by the rack arm system.

17) The method of claim 16 wherein said insulating material is composed of a material selected from the group of materials consisting of polypropylene, polyethylene, polystyrene, acrylic, Acrylonitrile butadiene styrene, styrene, or acrylonitrile.

18) The method of claim 16 wherein said method further comprises the step of adhering said cables and cable conduits to said protective cover via an insulated attachment means.

19) The method of claim 18 wherein said insulated attachment means are selected from the group consisting of cable ties, cable fasteners, and cable screw-type securing systems.
